(19) United States
(12) Patent Application Publication
(10) Pub. No.: US 2011/0049939 A1
(43) Pub. Date: Mar. 3, 2011

(54) VEHICLE ROOF HEADLINER AND METHOD OF MANUFACTURING THE SAME

(75) Inventors: Seung Soo RYU, Whasung-Si (KR); Hun Soo Kim, Whasung-Si (KR); Hee Jun Jeong, Whasung-Si (KR); Joo Yong Kim, Whasung-Si (KR); So Ya Hong, Suwon-si (KR)

(73) Assignees: Hyundai Motor Company, Seoul (KR); Foundation of Soongsil, Seoul (KR)

(21) Appl. No.: 12/619,445

(22) Filed: Nov. 16, 2009

(30) Foreign Application Priority Data
Sep. 1, 2009 (KR) 10-2009-0082067

(51) Int. Cl. B60R 13/02; B29C 47/00; B32B 38/00

(52) U.S. Cl. 296/214; 156/244.17

(57) ABSTRACT

A vehicle roof headliner which includes a back panel and a skin panel attached onto the back panel through a thermoforming process. The skin panel includes: an adhesive sheet serving as a medium of attaching the skin panel onto the back panel; an cushion sheet which is adhered on the adhesive sheet and is more flexible than the back panel; a cloth adhered on the cushion sheet; and a nanofiber unwoven fabric which is provided on a side of the cloth facing the cushion sheet, which is prepared by electrospinning a spinning solution containing a far infrared emitting material on the side of the cloth and which is melted during the thermoforming process and thus bonded with fiber tissues of the cloth. The vehicle roof headliner contributes to the improvement in health of vehicle passengers because it has excellent far infrared emission capability.

### CROSS-REFERENCE TO RELATED APPLICATIONS

The present application claims priority of Korean Patent Application Number 10-2009-0082067 filed on Sep. 1, 2009, the entire contents of which application is incorporated herein for all purposes by this reference.

### BACKGROUND OF THE INVENTION

1. Field of the Invention

The present invention relates to a vehicle roof headliner having excellent far infrared emission capability and a method of manufacturing the same.

2. Description of Related Art

Generally, a headliner, which is an interior material for finishing a vehicle roof, needs a good texture, cushioning ability, sound absorbency and the like.

Referring to FIG. 1, a conventional headliner has a structure in which an cushion sheet 11 and a cloth 12 are sequentially laminated on a hard back panel 10. Here, the back panel 10 serves to enable the headliner to maintain its shape, the cushion sheet 11 serves to provide a cushion to the headliner, and the cloth 12 serves to improve the texture and sound absorbency of the headliner.

Korean Unexamined Patent Application Publication Nos. 1999-0010721, 2006-0066584 and 2006-0043576 disclose methods of manufacturing such a headliner. However, in conventional technologies related to headliners, including these Publications, it seems that there is no consideration or attempt to provide a health care function to a headliner for vehicle passengers staying in a narrow and closed space while a vehicle is being driven or to improve the indoor environment of the vehicle.

Meanwhile, nanofiber is known as ultrafine fiber which has a diameter of several tens of nanometers to several hundreds of nanometers and whose surface area is much greater than its volume. Nanofibers are used to manufacture filters or clothes for defence against biochemical substances, and are prepared through an electrospinning process in which a polymer solution (a spinning solution) is used as the raw material and is spun into yarn by applying a high-voltage electric field. Korean Unexamined Patent Application Publication Nos. 2003-0048765, 2005-0071421 and 2006-0062661 disclose methods of preparing nanofiber.

Far infrared rays, which are infrared rays having a wavelength of 25 μm or more, are invisible, exhibit a strong thermal action and have strong penetration capability because they have longer wavelengths than visible rays. In particular, the thermal action of far infrared rays helps to eliminate bacteria causing various diseases, helps to promote the circulation of the blood and create cellular tissues by dilating capillaries, and helps to prevent aging, promote metabolism and prevent various adult diseases such as chronic fatigue syndrome and the like by activating cellular tissues. For this reason, it is well known that far infrared rays are put to practical use in various industrial and medical fields.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

One aspect of the present invention is to provide a vehicle roof headliner having excellent far infrared emission capability to improve the indoor environment of a vehicle.

Another aspect of the present invention is to provide a method of manufacturing a vehicle roof headliner having excellent far infrared emission capability through a simple process.

An aspect of the present invention provides a vehicle roof headliner which includes a back panel and a skin panel attached onto the back panel through a thermoforming process.

In the vehicle roof headliner, the skin panel includes: an adhesive sheet serving as a medium of attaching the skin panel onto the back panel; an cushion sheet which is adhered on the adhesive sheet and is more flexible than the back panel; a cloth adhered on the cushion sheet; and a nanofiber unwoven fabric which is provided on a side of the cloth facing the cushion sheet, which is prepared by electrospinning a spinning solution containing a far infrared emitting material on the side of the cloth and which is melted during the thermoforming process and thus strongly bonded with fiber tissues of the cloth.

In the vehicle roof headliner, the nanofiber unwoven fabric may include aluminum borate hydroxide nanofibers having a diameter of 100˜500 nm.

Another aspect of the present invention provides a method of manufacturing a vehicle roof headliner, including the steps of: supplying an cushion sheet; adhering a cloth to a side of the cushion sheet while heating the side of the cushion sheet, wherein the cloth is provided on the other side thereof with a nanofiber unwoven fabric formed by electrospinning a spinning solution containing a far infrared emitting material; and adhering an adhesive sheet to the other side of the cushion sheet while heating the other side of the cushion sheet.

The method of manufacturing a vehicle roof headliner may further include the step of layering a skin panel having a structure in which the cushion sheet and the cloth are sequentially layered on the adhesive sheet on a back panel which is harder than the skin panel to form a laminate and then applying heat and pressure to the laminate in a mold to form a headliner of a predetermined shape.

In the method, the spinning solution may be produced by the steps of: dissolving a polyvinylpyrrolidone (PVP) resin in ethanol to prepare a PVP polymer solution; mixing aluminum acetate containing boric acid as a stabilizer with a mixed solvent of ethanol and distilled water and then conducting a sol-gel reaction to prepare an aluminum hydroxide gel; and mixing the PVP polymer solution with the aluminum hydroxide gel.

In the method, the PVP resin may be included in the PVP polymer solution in an amount of 4˜6 wt % of the total amount of the PVP polymer solution.

In the method, the aluminum hydroxide gel may be configured such that the aluminum acetate is mixed in an amount of 0.15˜0.33 g per 1 ml of the mixed solvent in which ethanol and distilled water are mixed in a volume ratio of 1˜1.5:1.

In the method, the PVP polymer solution and the aluminum hydroxide gel may be mixed in a molar ratio of 0.8˜1.2:1.

### BRIEF DESCRIPTION OF THE DRAWINGS

FIG. 1 is a schematic sectional view showing a layered structure of a conventional headliner.

FIG. 2 is a schematic sectional view showing a layered structure of a headliner according to an embodiment of the present invention.

FIG. 3 is a schematic view showing a process of forming a nanofiber nonwoven fabric on the surface of a cloth shown in FIG. 2.

FIG. 4 is a schematic view showing a process of fabricating a skin panel.

FIG. 5 is a SEM photograph showing the nanofiber nonwoven fabric formed according to the process shown in FIG. 3.

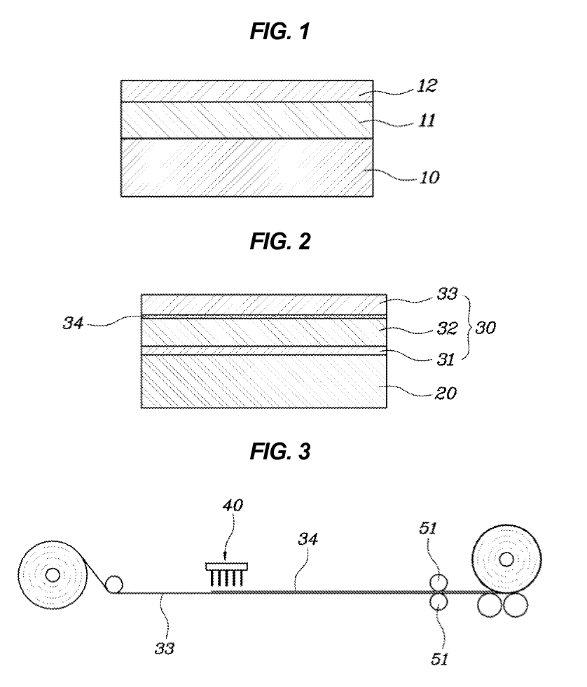

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A vehicle roof headliner according to an embodiment of the present invention will be described with reference to FIG. 2.

As shown in FIG. 2, a vehicle headliner includes a hard back panel 20 and a soft skin panel 30 which is relatively soft and attached to the back panel 20 through a thermoforming process. The skin panel 30 has a structure in which an adhesive sheet 31, an cushion sheet 32 and a cloth 33 are sequentially layered on the back panel 20. The skin panel 30 is attached to the back panel 20 by the medium of the adhesive sheet 31.

According to an embodiment of the present invention, a nanofiber nonwoven fabric 34 may be provided between the cushion sheet 32 and the cloth 33. This nanofiber nonwoven fabric 34 is formed by the electrospinning of a polymer solution containing a far infrared emitting material. The nanofiber nonwoven fabric 34 is melted through the thermoforming process, and then strongly bonded with the fiber tissues of the cloth 33. The nanofiber nonwoven fabric 34 includes aluminum borate hydroxide nanofibers having a diameter of 100˜500 nm.

When the headliner is mounted on a vehicle roof, the cloth 33 is disposed toward the interior of a vehicle. In this case, since the nanofiber nonwoven fabric 34 is provided on the back side (lower side shown in FIG. 2) of the thin cloth 33 which is directly exposed toward the interior of a vehicle, the far infrared emission rate of the headliner toward the interior of the vehicle is high. Moreover, since the nonwoven fabric 34 including aluminum borate hydroxide nanofibers has a high specific surface area and an ultrafine fiber diameter, it is highly efficient in its emission of far infrared radiation. Therefore, the nonwoven fabric 34 serves to improve the far infrared emission rate of the headliner toward the interior of the vehicle.

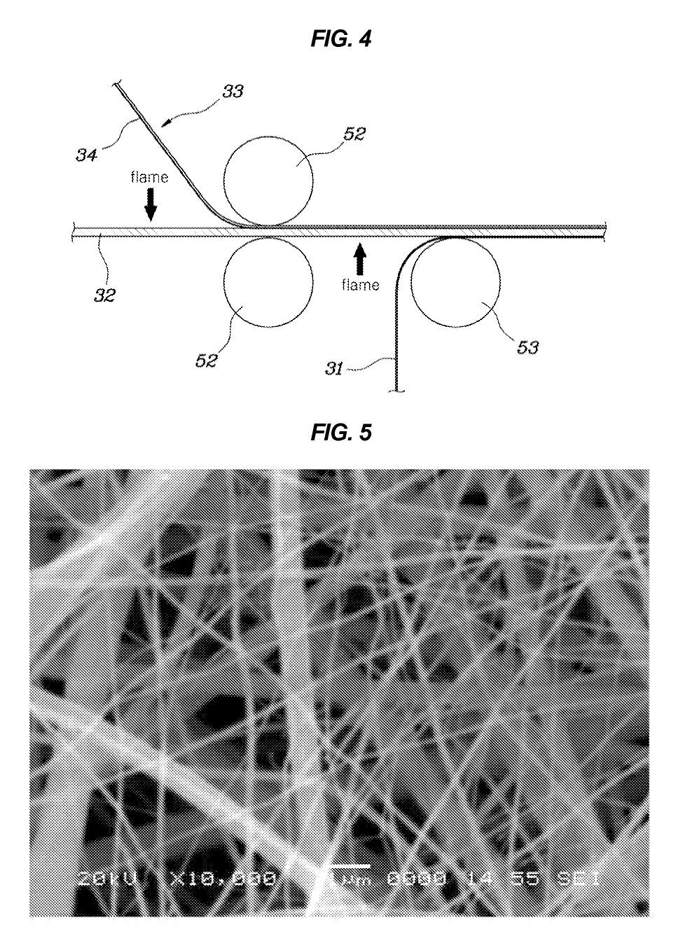

Hereinafter, a process of manufacturing a headliner according to an embodiment of the present invention will be described with reference to FIGS. 3 and 4.

Electrospinning Process

According to an embodiment of the present invention, the far infrared radiation properties of the headliner are obtained by previously forming a far infrared emitting layer, that is, the nanofiber nonwoven fabric 34, on the back side of the cloth 33 in the step of preparing a skin panel 30.

Referring to FIG. 3, a cloth 33 wound on a reel is unwound from the reel, and then a spinning solution containing a far infrared emitting material is electrospun on the back side of the cloth 33. Subsequently, the cloth electrospun with the spinning solution is wound again through pressure rollers. Here, the spinning solution electrospun on the back side of the cloth is formed into a nanofiber nonwoven fabric layer emitting far infrared rays.

As the spinning solution, a PVP polymer solution including aluminum acetate, serving as a precursor, containing boric acid as a stabilizer and a polyvinylpyrrolidone (PVP) resin serving as a support is used. Hereinafter, a process of preparing and electrospinning the spinning solution will be described in detail.

i) The PVP resin is dissolved in ethanol to prepare the PVP polymer solution.

In various embodiments, the PVP resin may be used in an amount of 4˜6 wt % of the total amount of the PVP polymer solution. When the amount of the PVP resin is less than 4 wt %, the spinnability of the spinning solution is not good in a voltage range of 10˜30 kV in which users can use the spinning solution safely because the viscosity of the spinning solution is not sufficient. When the amount of the PVC resin is more than 6 wt %, it is difficult to obtain nanofibers by electrospinning because the viscosity of the spinning solution is excessively high.

ii) The aluminum acetate containing boric acid is mixed with a mixed solvent of ethanol and distilled water and then stirred to prepare an aluminum hydroxide gel.

In various embodiments, the ethanol and the distilled water may be mixed in a volume ratio of 1˜1.5:1. When the volume ratio of ethanol and distilled water is below 1:1 and thus the amount of the used ethanol decreases, the mixed solvent is slowly volatilized, so it takes a long period of time to prepare the aluminum hydroxide gel, which is not economically effective. When the volume ratio of ethanol and distilled water is above 1.5:1 and thus the amount of the used ethanol increases, the amount of the distilled water participating in a gelation reaction relatively decreases, the gelation reaction is not conducted sufficiently.

The aluminum acetate is mixed in an amount of 0.15˜0.33 g, preferably, 0.17˜0.31 g per 1 ml of the mixed solvent. When the amount of the used aluminum acetate is less than 0.15 g, critically, 0.17 g per 1 ml of the mixed solvent, it is difficult to obtain a sufficient far infrared emission effect because the aluminum content is too low. When the amount of the used aluminum acetate is more than 0.33 g, critically, 0.31 g per 1 ml of the mixed solvent, the gelation reaction is not conducted sufficiently because aluminum acetate precursors, compared to the solvent, are present in excess in the aluminum sol solution and thus the amount of the aluminum acetate precursors which do not participate in hydrolysis or polycondensation increases.

In various embodiments, the mixed solution may be stirred for about 24 hours.

iii) The PVP polymer solution and aluminum hydroxide gel are mixed and then stirred to prepare a spinning solution.

The aluminum hydroxide gel and PVP polymer solution are mixed such that the molar ratio of aluminum acetate and PVP resin is 0.8˜1.2:1. When the amount of the aluminum hydroxide gel decreases and thus the molar ratio thereof is below 0.8:1, it is difficult to obtain a sufficient far infrared emission effect because the aluminum content is too low. When the amount of the aluminum hydroxide gel increases and thus the molar ratio thereof is above 1.2:1, it is difficult to conduct an electrospinning process in a voltage range of 10˜30 kV in which users can use the spinning solution safely because the viscosity of the spinning solution is excessively low

In various embodiments the mixed solution may be stirred for about 5 hours.

iv) The spinning solution is electrospun on the back side of a cloth 33.

The electrospinning of the spinning solution is performed using an electrospinning machine. Through the electrospinning process, an unwoven fabric including composite fibers in which aluminum hydroxide (specifically, aluminum borate hydroxide) and a PVP resin are mixed is formed on the back side of the cloth 33. FIG. 5 is an SEM photograph showing the nanofiber nonwoven fabric formed by spraying the spinning solution onto the back side of the cloth 33 while applying a spinning voltage of 20 kV to copper wire. As shown in FIG. 5, the nanofibers constituting the unwoven fabric have a diameter of 100˜500 nm.

Here, the spinning solution is prepared by mixing the aluminum hydroxide gel with the PVP polymer solution in a volume ratio of 1:1 and then stirring the mixture for 5 hours. The aluminum hydroxide gel is prepared by mixing aluminum acetate (product number 294853, manufactured by Aldrich Corp.) containing a small amount of boric acid as a stabilizer with a mixed solvent in which ethanol and distilled water are mixed in a volume ratio of 1.3:1 in an amount of 0.26 g per 1 ml of the mixed solvent and then stirring the mixture at room temperature for 24 hours. The PVP polymer solution is prepared by dissolving 5 wt % of a PVP resin in ethanol at room temperature. A copper plate is used as a counter electrode.

Process of attaching cloth onto an cushion sheet

A skin panel 30 is fabricated using the above electrospun cloth 33. As shown in FIG. 4, the skin panel 30 is continuously fabricated while supplying a previously-fabricated or currently-fabricated cushion sheet 32 along a process line.

Referring to FIG. 4, the upper side of the cushion sheet 32 moving along the process line is flame-heated and thus partially melted. Then, a cloth 33 wound on a reel is unwound from the reel, layered on the upper side of the partially melted cushion sheet 32, and then pressed by pressure rollers 52 to be attached to the cushion sheet 32. The cloth 33, which is to be attached to the cushion sheet 32, is provided on the lower side thereof with the nanofiber unwoven fabric. Polyurethane foam is used as the cushion sheet 32. In addition to polyurethane foam, polyethylene-based foam or polypropylene-based foam may be used as the cushion sheet 32.

Process of Attaching an Adhesive Sheet Beneath the Cushion Sheet

As shown in FIG. 4, an adhesive sheet 31 is attached onto the lower side of the cushion sheet 32 supplied along the process line. Specifically, the lower side of the cushion sheet 32 moving along the process line is flame-heated and thus partially melted. Then, the adhesive sheet 31 wound on a reel is unwound from the reel, layered on the lower side of the partially melted cushion sheet 32, and then pressed by a pressure roller 53 to be attached to the cushion sheet 32. As the adhesive sheet 31, nylon-based foam or polypropylene-based foam may be used.

Through the above processes, the skin panel in which the cushion sheet 32 and cloth 33 are sequentially layered on the adhesive sheet 31 is fabricated. Meanwhile, the process of fabricating the skin panel 30, shown in FIG. 4, is only an example of skin panel fabrication processes. The order in which the cloth 33 is attached to the cushion sheet 32 and then the adhesive sheet 31 is attached to the cushion sheet 32 may be reversed if necessary.

Thermoforming Process

A headliner is manufactured using the skin panel 30 fabricated through the above processes. Specifically, the skin panel 30 is layered on the back panel 20 such that the adhesive sheet 31 of the skin panel 30 faces the back panel 20, heated, and then pressed to manufacture a headliner having a predetermined shape. During the heating procedure, the adhesive sheet 31 of the skin panel 30 is partially melted to make the skin panel 30 soft. The adhesive sheet 31 partially melted during the heating procedure serves as the medium of attaching the skin panel 30 to the back panel 20 in the press forming process.

Meanwhile, the nanofiber unwoven fabric 34, in which the aluminum hydroxide and PVP resin are mixed, is melted during the heating procedure and thus strongly bonded with fiber tissues of the cloth 33, so that the cloth 33 does not separate easily from the cushion sheet 32. Further, this nanofiber unwoven fabric 34 has a high far infrared emission rate of 93% or more, thus greatly improving the coziness of the interior of a vehicle.

As described above, the present invention provides a vehicle roof headliner having excellent far infrared emission capability.

Further, the present invention provides a method of manufacturing a vehicle roof headliner having excellent far infrared emission capability through a simple process.

For convenience in explanation and accurate definition in the appended claims, the terms “upper” or “lower”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle roof headliner, comprising:
a back panel; and
a skin panel attached onto the back panel through a thermoforming process, wherein the skin panel includes:
an adhesive sheet serving as a medium of attaching the skin panel onto the back panel;
an cushion sheet which is adhered on the adhesive sheet and is more flexible than the back panel;
a cloth adhered on the cushion sheet; and
a nanofiber unwoven fabric which is provided on a side of the cloth facing the cushion sheet, which is prepared by electrospinning a spinning solution containing a far infrared emitting material on the side of the cloth and which is melted during the thermoforming process and thus bonded with fiber tissues of the cloth.

2. The vehicle roof headliner according to claim 1, wherein the nanofiber unwoven fabric includes aluminum borate hydroxide nanofibers having a diameter of 100˜500 nm.

3. A method of manufacturing a vehicle roof headliner, comprising the steps of
supplying an cushion sheet;
adhering a cloth to a side of the cushion sheet while heating the side of the cushion sheet, wherein the cloth is provided on the other side thereof with a nanofiber unwoven fabric formed by electrospinning a spinning solution containing a far infrared emitting material; and
adhering an adhesive sheet to the other side of the cushion sheet while heating the other side of the cushion sheet.

4. The method of manufacturing a vehicle roof headliner according to claim 3, further comprising the step of layering a skin panel having a structure in which the cushion sheet and the cloth are sequentially layered on the adhesive sheet on a back panel which is harder than the skin panel to form a laminate and then applying heat and pressure to the laminate in a mold to form a headliner of a predetermined shape.

5. The method of manufacturing a vehicle roof headliner according to claim 3 or 4, wherein the spinning solution is produced by the steps of:
dissolving a polyvinylpyrrolidone (PVP) resin in ethanol to prepare a PVP polymer solution;
mixing aluminum acetate containing boric acid as a stabilizer with a mixed solvent of ethanol and distilled water and then conducting a sol-gel reaction to prepare an aluminum hydroxide gel; and
mixing the PVP polymer solution with the aluminum hydroxide gel.

6. The method of manufacturing a vehicle roof headliner according to claim 5, wherein the PVP resin is included in the PVP polymer solution in an amount of 4˜6 wt % of the total amount of the PVP polymer solution.

7. The method of manufacturing a vehicle roof headliner according to claim 6, wherein the aluminum hydroxide gel is configured such that the aluminum acetate is mixed in an amount of 0.15˜0.33 g per 1 ml of the mixed solvent in which ethanol and distilled water are mixed in a volume ratio of 1˜1.5:1.

8. The method of manufacturing a vehicle roof headliner according to claim 7, wherein the PVP polymer solution and the aluminum hydroxide gel are mixed in a molar ratio of 0.8˜1.2:1.
